(19) United States
(12) Patent Application Publication
(10) Pub. No.: US 2024/0343995 A1
(43) Pub. Date: Oct. 17, 2024

(54) LAUNDRY SANITIZING AND SOFTENING COMPOSITION

(71) Applicant: Reckitt Benckiser Health Limited, Slough Berkshire (GB)

(72) Inventor: Miriam Diaz, Montvale, NJ (US)

(21) Appl. No.: 18/716,337

(22) PCT Filed: Dec. 6, 2022
(86) PCT No.: PCT/GB2022/053095

§ 371 Date: Jun. 4, 2024

Related U.S. Application Data
(60) Provisional application No. 63/286,177, filed on Dec. 6, 2021.

(30) Foreign Application Priority Data
Feb. 22, 2022 (GB) 2202402.0

(51) Int. Cl. C11D 1/62; C11D 1/72; C11D 1/835; C11D 3/00; C11D 3/20; C11D 3/48

(52) U.S. Cl. CPC C11D 1/62; C11D 1/72; C11D 1/835; C11D 3/0015; C11D 3/2013; C11D 3/48; C11D 2111/12

(57) ABSTRACT

The present invention relates to a laundry sanitizing and softening composition to be added to a laundry washing process to provide improved reduction in bacteria during a laundry washing process while also providing fabric softening.

The present invention relates to a laundry sanitizing and softening composition to be added to a laundry washing process to provide improved reduction in bacteria and viruses during a laundry washing process while also providing fabric softening.

### BACKGROUND

Consumers have increased interest in washing laundry under energy and water efficient conditions due to environmental concerns, and also washing with laundry compositions with reduced environmental impact, such as less environmentally harmful laundry detergents. Consumers are therefore interested in washing laundry at cooler temperatures, with less water and with milder laundry detergents. Washing laundry under these conditions raises concerns that the resulting items may be visibly clean but may be unhygienic because they may still harbour pathogens. Therefore, there is a growing demand for laundry sanitizing compositions to ensure that clean laundry harbours fewer pathogens. However, laundry sanitizing compositions are added to the fabric softener drawer of the washing machine, making it difficult to use both laundry sanitizing compositions and fabric softener compositions in the same wash cycle.

Liquid fabric softener (also known as fabric conditioner) compositions are typically a dispersion of cationic quaternary ammonium surfactants in an aqueous carrier. These cationic quaternary ammonium surfactants form positively charged vesicles dispersed in the carrier. Adding further cations to the system may affect the stability of the vesicles, leading to flocculation. Thus, it has been difficult to combine in a single composition the actives used in laundry sanitizing compositions, typically cationic biocidal agents, with the cationic quaternary ammonium surfactants used as fabric softening agents in liquid fabric softeners.

WO 96/21715 seeks to provide a means for stabilizing dispersions of cationic fabric softeners in liquid carriers, particularly those containing added electrolytes, by using certain polymers incorporated into concentrated fabric softener compositions to enhance stability. In particular, when formulating fabric softeners with higher concentrations of cationic surfactant it is usually desirable to incorporate materials such as inorganic electrolytes, e.g. to de-water the softener vesicles and to incorporate perfume with the cationic vesicles to stabilise the perfume. It is suggested that the polymers interact with the cationic softener vesicles, inhibiting their coalescence in the presence of high ionic strength, such as when adding further cations to the system. Suggested polymers are water-soluble polyesters that can be formed from: (1) ethylene glycol, 1,2-propylene glycol or a mixture thereof; (2) a polyethylene glycol (PEG) capped at one end with a C₁₋₄ alkyl group; and (3) a dicarboxylic acid (or its diester).

U.S. Pat. No. 3,349,033 relates to microbiologically active softeners. It discusses how mixtures of germicidal quaternary ammonium salts with fabric softeners are unstable, remaining homogeneous for at most a few weeks. This instability is allegedly overcome by adding a small amount of an emulsifier (e.g. a long chain fatty alcohol) to the mixture causing the mixture to remain homogenously emulsified for longer and under successive freeze-thaw cycles. The long chain fatty alcohol emulsifiers are disclosed to be C₁₀₋₁₈ fatty alcohols, such as “topped fatty alcohols” like “Lorol 5”, disclosed to have an alkyl chain distribution of 3% C₁₀, 61% C₁₂, 23% C₁₄, 11% C₁₆ and 2% C₁₈. The cationic quaternary ammonium softeners discussed are of the formula NR′R″R″R″′X, where R and R′ are C₁₀₋₂₀ alkyl groups; R″ is methyl; R″′ is methyl, ethyl or (CH₂—CHO)ₙH where n>0, and X is chlorine, bromine, sulfate, methosulfate or ethosulfate. An example of a common contemporaneous cationic quaternary ammonium softener is di-(hydrogenated tallow) dimethyl ammonium methosulfate, which has since been superseded by more biodegradable compounds, such as esterquats. The germicidal quaternary ammonium salts used in U.S. Pat. No. 3,349,033 are of the single-chain variety, such as Alkyl Dimethyl Benzyl Ammonium Chloride (“ADBAC” or “BKC”). Germicidal quaternary ammonium salts have developed considerably since U.S. Pat. No. 3,349,033 with Alkyl Dimethyl EthylBenzyl Ammonium Chloride (“ADEBAC” or “EBC”) and Dialkyl Dimethyl Ammonium Chloride (“DDAC”, a twin-chain quat) becoming available, as well as mixtures of these quaternary ammonium salts. DDAC is the most efficacious germicidal quaternary ammonium and has improved tolerance for anionic surfactants, organic loads and hard water compared with the single-chain quats BKC and EBC. EBC is typically used in combination with BKC. Both the germicidal quaternary ammonium salts and the fabric softener actives have therefore advanced considerably since U.S. Pat. No. 3,349,033.

U.S. Pat. No. 4,476,030 relates to concentrated masterbatches of fabric softeners, for instance containing distearyl-dimethylammonium chloride. However, U.S. Pat. No. 4,476,030 is not concerned with reduction of bacteria and viruses during a laundry washing process.

WO2002/072745A1 provides a rinse added composition for the conditioning of fabric in a rinse, the composition comprising a fabric softener active, a suds suppressing system and a surfactant scavenger.

WO2006/094582A1 discusses how consumers prefer liquid fabric conditioners that appear thick and creamy, which is indicated by having a high viscosity and a high opacity. Thin, translucent, or watery liquid fabric conditioners are perceived as cheap and/or ineffective. WO2006/094582A1 suggests that polymeric viscosity modifiers may be used to impart a high viscosity and opacity to the composition and uses water-soluble polysaccharide polymers to this effect.

WO97/47716A2 describes aqueous softening dispersions containing 0.5 to 20 wt % of at least one non-ionic fat, 0.2 to 10 wt % of a water-soluble or insoluble cationic emulsifier and possibly up to 10 wt % of a non-ionic emulsifier, in which the weight ratios between fat and emulsifiers is between 10:1 and 0.5:1, and which are alleged to exhibit a good soft-care effect if the zeta potential of the dispersion is at least +30 mV at 25° C. and a pH of 7.

GB2207446 relates to aqueous fabric softening compositions based on cationic fabric softeners and fatty alcohols. The weight ratio of cationic softening agent to fatty alcohols is in the range of from about 6:1 to 2.8:1.

WO02/20706A1 describes a method of preparing an aqueous dispersion of a fabric conditioning composition comprises mixing 7.5 to 60 wt % of a cationic fabric softening compound with 0.01%-1.5 wt % of a non-ionic surfactant viscosity modifier and up to 1.4% by weight of a fatty alcohol, the combination of (b) and (c) being no more than 1.5% by weight, based on the total weight of the composition. Saturated fatty alcohols are preferred as these were considered to deliver greater benefits in terms of stability, especially low temperature stability.

WO03/022972A1 also describes a method of preparing an aqueous, liquid fabric conditioning composition wherein saturated fatty alcohols are preferred as these were considered to deliver greater benefits in terms of stability, especially low temperature stability.

Dettoll® Laundry Cleanser is one commercially available product that is used for sanitizing clean laundry. It contains the dialkyl (C₈₋₁₀) dimethylammonium chloride (DDAC) and benzyl-C₁₂₋₁₈-alkyldimethyl chloride (ADBAC). Typically, about 120 ml of Dettol® Laundry Cleanser is added to the fabric softener drawer of the washing machine so that it is used in the washing machine rinse cycle. Dettol® Laundry Cleanser kills 99.9% of bacteria (i.e. a 3-log reduction in bacteria) in laboratory tests.

There remains a need for laundry softener compositions that also provide germ kill.

It is an object of the invention to provide a laundry softener composition that also provides germ kill during a laundry rinse cycle.

### STATEMENT OF INVENTION

In a first aspect, the invention provides a laundry composition comprising.
a) about 1 to about 5 wt % of at least one cationic biocidal active;
b) about 1 to about 25 wt % of at least one cationic fabric softener, and
c) about 0.5 to about 4 wt % of at least one emulsifier,
wherein the at least one emulsifier is an unsaturated fatty alcohol and
wherein the at least one cationic fabric softener is a cationic quaternary ammonium surfactant containing ester linkages (esterquat).

In a further aspect, the invention provides the use of an unsaturated fatty alcohol (such as those described herein) for stabilising a cationic liquid dispersion containing at least one cationic surfactant. Preferably, the use of an unsaturated fatty alcohol (such as those described herein) for preventing flocculation in a cationic liquid dispersion containing at least one cationic surfactant. The at least one cationic surfactant may be a cationic biocide (such as a cationic quaternary ammonium surfactant, e.g. those described herein), a fabric softener (such as those described herein), and a combination of a cationic biocide and a fabric softener. The carrier liquid may be aqueous. The liquid dispersion may be a dispersion of vesicles.

In yet a further aspect, the invention provides a method of stabilising a cationic liquid dispersion containing at least one cationic surfactant, comprising adding an unsaturated fatty alcohol emulsifier (such as those described herein) to a liquid dispersion containing the at least one cationic surfactant. The unsaturated fatty alcohol prevents flocculation in the liquid dispersion, thus stabilising the cationic liquid dispersion. The cationic surfactant may be a cationic biocidal active (such as a cationic quaternary ammonium surfactant, e.g. those described herein), a cationic fabric softener (such as those described herein), and a combination of a cationic biocidal active and a cationic fabric softener. The carrier liquid may be aqueous. The liquid dispersion may be a dispersion of vesicles.

### Cationic Fabric Softener

The at least one fabric softener is a cationic quaternary ammonium surfactant containing ester linkages, commonly called an esterquat. Preferably, the at least one fabric softener is a cationic quaternary ammonium surfactant derivable from the reaction of triethanolamine with fatty alcohols. More preferably, the fatty alcohols are partially hydrogenated. The fatty alcohols may be derived from plant oils (e.g. palm, palm kernel or coconut oil) or animal sources (e.g. tallow). The cationic fabric softener may be a partially hydrogenated palm esterquat (such as Tetranyl® L6/90 available from Kao) or a partially hydrogenated tallow esterquat (e.g. dihydrogenerated tallowethyl, ditallowethyl hydroxyethylmonium methosulfate, such as Tetranyl® AT7590 available from Kao)).

### Emulsifier

The at least one emulsifier is an unsaturated fatty alcohol. Preferably, the at least one unsaturated fatty alcohol contains at least one cis double bond. More preferably, the at least one unsaturated fatty alcohol is a monounsaturated fatty alcohol. The at least one unsaturated fatty alcohol may be a C₈₋₂₆ unsaturated fatty alcohol, or a C₁₀₋₂₆ unsaturated fatty alcohol. Preferably, the at least one unsaturated fatty alcohol is a C₁₂₋₂₆ unsaturated fatty alcohol, more preferably the at least one unsaturated fatty alcohol is a C₁₆₋₂₂ unsaturated fatty alcohol. The unsaturated fatty alcohol may be oleyl alcohol (cis-9-octadecen-1-ol), palmitoleyl alcohol (cis-9-hexadecen-1-ol), erucyl alcohol (cis-13-docosen-1-ol), preferably oleyl alcohol (cis-9-octadecen-1-ol).

### Cationic Biocidal Active

The at least one cationic biocidal active may be selected from one or more quaternary ammonium compounds. Quaternary ammonium compounds are compounds of the formula (N⁺R¹R²R³R⁴)X⁻, where X⁻ is a salt-forming anion which permits water solubility of the quaternary ammonium compounds, and is, for example, chloride, bromide or iodide or a methosulfate anion. Any quaternary ammonium compound with antimicrobial activity may be used in the invention.

The at least one cationic biocidal active agent may be selected from one or more dialkyldimethyl ammonium chlorides (DDAC), where each alkyl group is independently selected from straight chain C₈-C₁₀ alkyl.

The at least one cationic biocidal active agent may be selected from one or more alkyl dimethyl benzyl ammonium chlorides (ADBAC also known as BKC):

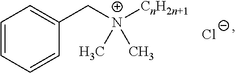

where n=8-18, preferably n=12-14 as these chain lengths are the most biocidal.

The at least one cationic biocidal active agent may be selected from one or more alkyl dimethyl ethylbenzyl ammonium chlorides (ADEBAC also known as EBC), which are preferably C₈₋₁₂-alkyl [(ethylphenyl) methyl] dimethyl chlorides.

Preferably, the at least one cationic biocidal active agent is selected from ADBAC, ADEBAC, DDAC and combinations thereof, such as ADBAC and DDAC, or ADBAC and ADEBAC, or ADBAC, ADEBAC and DDAC. More preferably, the at least one cationic biocidal active agent is BKC or DDAC or a combination of ADBAC and DDAC. Most preferably, the at least one cationic biocidal active agent is a mixture of ADBAC and DDAC.

The at least one cationic biocidal active agent and the cationic fabric softener are different.

### Additional Components

The laundry composition may contain chelating agents. In particular, the laundry composition may contain aminopolycarboxylates (such as EDTA); nitrilotriacetic acid (NTA); iminodisuccinic acid (IDS); polyaspartic acid; S,S-ethylenediamine-N,N′-disuccinic acid (EDDS); methylglycinediacetic acid (MGDA); and L-Glutamic acid N,N-diacetic acid, tetrasodium salt (GLDA).

The laundry composition may contain organic acids and/or salts thereof. In particular, the laundry composition may contain organic acids that have antimicrobial activity, such as glycolic acid, citric acid, formic acid, sorbic acid, lactic acid, acetic acid, propionic acid, malic acid and mixtures thereof. Preferably, the organic acid is glycolic acid or a salt thereof.

The laundry composition may contain antifoam agents. In particular, the laundry composition may contain silicone antifoam emulsions such as those available from Wacker as SILFOAM®.

The laundry composition may contain pH adjusting agents. In particular, the laundry composition may contain sulfuric acid.

### Weights

The at least one cationic biocidal active is present in the laundry composition at about 1 to about 5 wt % of the composition. Preferably, the at least one cationic biocidal active is present at about 2 to about 4 wt % of the laundry composition. More Preferably, the laundry composition comprises about 2.4 wt % or about 3.36 wt % of the at least one cationic biocidal active.

The at least one cationic fabric softener is present in the laundry composition at about 1 to about 25 wt % of the composition. Preferably, the at least one cationic fabric softener is present at about 1 to about 10 wt % of the laundry composition, more preferably at about 1 to about 5 wt %, yet more preferably at about 2 to about 4 wt % of the laundry composition. More preferably, the laundry composition comprises about 2.7 wt % of the at least one cationic fabric softeners. Alternatively, the at least one cationic fabric softener may preferably be present in the laundry composition at about 3 to about 15 wt % of the laundry composition, more preferably at about 3 to about 10 wt %.

The at least one emulsifier is present in the laundry composition at about 0.5 to about 4 wt % of the composition. Preferably, the at least one emulsifier is present at about 1 to about 3 w %%1 of the laundry composition. More preferably, the laundry composition comprises about 2 wt % of the at least one emulsifier.

The weight ratio of the at least one cationic biocidal active:at least one cationic fabric softener:at least one emulsifier may be 1-40:1-40:1, preferably, about 1.2:1.35:1.

In one embodiment, the laundry composition comprises:
i. about 1.44 wt % or about 2.4 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzyl ammonium chloride:

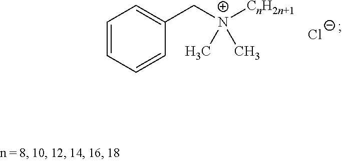

iii. about 2.70 wt % of cationic fabric softeners, and
iv. about 2.00 wt % oleyl alcohol.

The laundry composition may further comprise:
v. about 1 wt % solvent, such as propylene glycol, and
vi. about 1 wt % non-ionic surfactant, such as alcohol ethoxylates.

The laundry composition may optionally further comprise a pH adjuster, such as sulphuric acid.

In one embodiment, from about 30 to about 180 ml, preferably about 120 ml, of the laundry composition of the invention at about 1:159 dilution with water achieves at least a 4-log reduction according to the EN1276:2009 protocol, under clean conditions in no more than 22 minutes at 20° C. Preferably, from about 30 to about 180 ml, preferably about 120 ml, of the laundry composition of the invention at about 1:159 dilution with water achieves at least a 5-log reduction according to the EN1276:2009 protocol, under clean conditions in no more than 22 minutes at 20° C.

In a second aspect, the invention provides a method of sanitizing laundry during a laundry washing process comprising adding from about 30 to about 180 ml, preferably about 120 ml, of the laundry composition described herein to the fabric softener compartment of an automatic washing machine and using the automatic washing machine to perform a laundry washing process.

In a third aspect, the invention provides the use of an unsaturated fatty alcohol emulsifier as described herein in stabilising a laundry composition comprising at least one cationic biocidal active and a cationic fabric softener.

The inventors have surprisingly found that the inclusion of an unsaturated fatty alcohol emulsifier in a laundry composition comprising a cationic fabric softener and a cationic biocidal agent produced stable laundry fabric softeners compositions that provide germ kill during a laundry process.

In particular, the inventors have surprisingly found that an unsaturated fatty alcohol improves the stability of a laundry composition comprising a cationic fabric softener and a cationic biocidal agent. Indeed, the laundry composition of the invention is surprisingly stable at 60° C., which is particularly unusual for fabric softener.

### Terms and Definitions

As used herein:
the terms “approximately” and “about” mean plus or minus 10% of the value stated;
the term “a” or “an” means one or more;
any and all ranges are inclusive of their endpoints, e.g. a range of from 1 wt % to 10 wt % w/w includes 1 wt % and 10 wt % and any concentration between 1 wt % and 10 wt %;
all amounts given in % are % by weight (wt %) unless otherwise stated;
the term “benzyl group” is C₆H₅CH₂—;
the term “comprising” means “includes” and encompasses the terms “consisting of” and “consisting essentially of”; i.e. the compositions of the invention comprising the components as herein defined may consist essentially of these components or may consist of these components.

### EXAMPLES

The following examples illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

### Samples

In the following examples the biocidal actives used were DDAC and BKC. These biocides are typically provided as solutions containing DDAC or BKC and solvents, typically selected from water, ethanol, isopropyl alcohol, ethylene glycol and mixtures thereof. In the following examples the DDAC used was Acticide® DDQ80 (Thor) or Bardac® 2080 (Lonza), both are twin chain dimethyl ammonium chloride compositions comprising 80% actives with the balance comprising water and ethanol. In the following examples the BKC used was Acticide® BAC 80 (Thor) or BTC 1218-80 (Stepan), which comprise 80% actives (alkyl (C12-18) dimethylbenzyl ammonium chloride) with the balance comprising water and ethanol.

In the following examples the fabric softening active used was Tetranyl® AT-7590 (Kao), which contained 90% active matter (partially hydrogenated tallow esterquat) and 10% isopropyl alcohol (IPA).

In the following examples the surfactant was Genapol® LA 070 (Alcohol ethoxylate C12-16, 7EO, Clariant) and the solvent was propylene glycol (DOW).

### Sample Preparation

The following formulations were made by adding the raw materials step wise with mixing, waiting until the mixture was homogenous after each material was added before adding the next raw material. The raw materials were added in the following order.
1. Deionised water
2. Emulsifier (if used)
3. Solvent
4. Surfactant
5. DDAC
6. BKC
7. Esterquat
8. Deionised water

The final step of deionised water was added in an amount sufficient to achieve the desired amount of active, e.g. 1.8 wt % DDAC, 1.2 wt % BKC and 3 wt % esterquat and included a fragrance, if used.

| Ingredient | | A | B | C | D |
|---|---|---|---|---|---|
| Deionized Water | | 92.00 | 90.00 | 90.00 | 90.00 |
| Propylene Glycol | | 1.00 | 1.00 | 1.00 | 1.00 |
| Genapol ® LA 070 | | 1.00 | 1.00 | 1.00 | 1.00 |
| DDAC | | 1.80 | 1.80 | 1.80 | 1.80 |
| BKC | | 1.20 | 1.20 | 1.20 | 1.20 |
| Esterquat | | 3.00 | 3.00 | 3.00 | 3.00 |
| Emulsifier | Cetyl alcohol | n/a | 2.00 | | |
| | Stearyl alcohol | | | 2.00 | |
| | Lauryl alcohol | | | | 2.00 |

| Ingredient | | 1 | 2 | 3 | 4 |
|---|---|---|---|---|---|
| Deionized Water | | 89.75 | 90.00 | 90.00 | 90.00 |
| Propylene Glycol | | 1.00 | 2.00 | 1.00 | 1.00 |
| Genapol ® LA 070 | | 1.00 | 1.00 | 1.00 | 1.00 |
| DDAC | | 1.80 | 1.80 | 1.80 | 1.80 |
| BKC | | 1.20 | 1.20 | 1.20 | 1.20 |
| Esterquat | | 3.00 | 3.00 | 3.00 | 3.00 |
| Emulsifier | Oleyl alcohol | 2.00 | 2.00 | | |
| | Cis-9-hexadecenol | | | 2.00 | |
| | Cis-13-docosenol | | | | 2.00 |

| | |
|---|---|
| Fragrance | 0.25 |

### Stability Tests

The above samples were tested for stability. The stability was quantified by measuring the zeta potential of the sample using a Malvern Zetasizer Nano Series ZEN 3600.

| | | | Zeta |
|---|---|---|---|
| | | | potential at |
| Sample | Emulsifier | Stability | 25° C./mV |
| A | None | Unstable even at RT | 55.5 |
| B | Cetyl alcohol | Unstable, very dependent | 56.6 |
| | | on process | |
| C | Stearyl alcohol | Unstable even at RT | 56.6 |
| D | Lauryl alcohol | Stable but translucent | 72.7 |
| 2 | Oleyl alcohol | Stable over 1 year at all | 72.0 |
| | | conditions | |
| 3 | cis-9-hexadecen- | Stable over 26 weeks at all | 73.0 |
| | 1-ol | conditions | |
| 4 | cis-13-docosen- | Stable over 26 weeks at all | 71.3 |
| | 1-ol | conditions | |

### Results

Sample A containing no emulsifier was unstable even at room temperature. The samples containing the saturated emulsifiers cetyl alcohol (Sample B) and stearyl alcohol (Sample C) were unstable, even at room temperature, and had comparable zeta potential values to the sample without an emulsifier, Sample A Sample D containing the short-chain saturated emulsifier lauryl alcohol was stable but was translucent; consumers prefer opaque laundry softeners and so Sample D was not considered commercially viable. The samples containing unsaturated emulsifiers, Samples 2-4, were found to be stable over prolonged periods of time and at all conditions. A zeta potential of greater than 60 mV was considered necessary.

Two samples were prepared using a different order of mixing to those above. Both samples contained 4% biocide, rather than the 3% used above. Both samples contained oleyl alcohol as the emulsifier. One sample used the same esterquat as the samples above. i.e. Tetranyl® AT7590. The other sample used a partially hydrogenated palm esterquat, Tetranyl® L6/90 (Kao), which was similar to the Tetranyl® AT7590 and contained 90% active matter and 10% IPA. Both samples were stable over 12 weeks at all conditions. The tallow-based esterquat had a zeta potential of 73.6 mV at 25° C. and the palm-based esterquat had a zeta potential of 74.6 mV at 25° C.

Thus, the samples containing unsaturated emulsifiers were found to be stable over prolonged periods of time and at all conditions even using a different method of manufacture Antimicrobial Efficacy (British Standard) Two samples according to the invention (Sample 5 and Sample 6) were evaluated for their antimicrobial efficacy against Staphylococcus aureus (ATCC 6538), Escherichia coli (ATCC 10536), Pseudomonas aeruginosa (ATCC 15442) and Enterococcus hirae (ATCC 10541) using an antimicrobial suspension test based on British Standard reference No: EN 1276:2009 method entitled “Chemical Disinfectants and Antiseptics—Quantitative Suspension Test for the Evaluation of bactericidal activity of chemical disinfectants and antiseptics used in food, industrial, domestic and institutional areas—Test method and requirements (Phase 2, step 1)”. A greater than 5-log reduction of all organisms (Pseudomonas aeruginosa, Staphylococcus aureus, Enterococcus hirae, Escherichia col) for a contact time of 1 to 60 minutes (determined by product specification) at a testing temperature ranging from 4° C. to 60° C.+1.0° C. (determined by product specification) is required to pass the EN1276. Additional and optional contact times, temperatures, and test organisms can be used.

The test protocol tests the efficacy of the compositions of the present invention and the comparative examples against gram-negative and gram-positive bacteria. The test organisms used were Staphylococcus aureus (ATCC 6538), Escherichia coli (ATCC 10536), Pseudomonas aeruginosa (ATCC 15442) and Enterococcus hirae (ATCC 10541).

The bacterial strains were cultured on tryptic soy agar (TSA) slant from frozen stock and incubated for 18-24 hours. Following incubation, 2^{nd} and 3^{rd} generation transfers were prepared and used to prepare test suspensions as described in the BS EN 1276:2009 test method. The working culture must be either a second or third generation subculture on TSA slants from a cryogenic stock. The cell suspensions were adjusted to produce approximately 1.5−5.0×10⁸ CFU mL⁻¹. Subcultures were prepared on TSA slants and incubated at 36:1° C. for 18-24 hours. The growth medium and temperature used were TSA and 36±1° C. Test solutions and test cultures are equilibrated to a test temperature of 20±1° C. in a water bath.

The tests were performed using “clean” experimental conditions, i.e. 0.3 g/l Bovine Albumin (BA) in-test concentration, rather than “dirty” experimental conditions, i.e. 3 g/l BA in-test concentration. For laundry sanitizers/softeners, the desired experimental conditions are “clean conditions” because the laundry sanitizer/softener is used after a laundry detergent in a laundry washing process. i.e. on clean laundry.

Experimentally, a 1:1 dilution of the test culture and test conditions was performed and allowed to react for 2 minutes. 2.0 mL of the test culture was exposed to 8.0 mL of the test product for a 22-minute contact time and then a 1.0 mL aliquot was neutralized in a verified neutralizer. After a 5-minute neutralization time, the neutralized sample was serially diluted, plated on TSA and incubated at 36±1° C. for 48 hours. The average Log₁₀ CFU/mL for the test suspension was calculated and used to compute the log reduction post-treatment. At least a 5-log reduction of all organisms tested for a 22-minute contact time was chosen to indicate that the tested formulation has the desired level of antimicrobial properties against tested organisms. Log reduction greater than 4 means >99.99% reduction in the number of cells; log reduction greater than 5 means >99.999% reduction in the number of cells and denotes complete kill.

Sample 5 was prepared as follows.
1. 439.52 g of soft water was added to the beaker and heated to 40° C.
2. The following were then added while constantly mixing in between each addition:
   0.03 g of Silfoam® SE 39 (antifoam agent, Wacker),
   2.50 g of ROKAnol® L7A (C12-16 Laureth-7, PCC),
   5.00 g propylene glycol,
   10.00 g of oleyl alcohol,
   12.75 g of DDAC (Arquad® 2.1-80, Nouryon) and
   5.40 g of BKC (Coco(fractionated)benzyldimethylammonium chloride, Arquad® MCB-80, Nouryon).
3. The beaker was heated to 45° C.
4. 15.00 g of Tetranyl® AT7590 was pre-melted at 50° C. and added to the beaker once the temperature was at 50° C.
5. The mixing speed was increased as the viscosity built and mixing continued for 10 minutes.
6. The following were then added while mixing: 2.00 g of dye, 2.80 g of fragrance and 5.00 g of soft water.
7. The batch was cooled before pouring into a container for storage.

The final amounts are given in the table below.

| Ingredient | Function | % w/w |
|---|---|---|
| Soft Water | Solvent | 88.904% |
| Silfoam ® SE 39 | Antifoam | 0.006% |
| ROKAnol ® L7A | Surfactant | 0.50% |
| Propylene glycol | Solvent | 1.00% |
| Oleyl alcohol | Emulsifier | 2.00% |
| Arquad ® 2.1-80 | Active | 2.550% |
| Arquad ® MCB-80 | Active | 1.080% |
| Tetranyl ® AT7590 | Softener | 3.00% |

| | |
|---|---|
| Dye | 0.40% |
| Fragrance | 0.56% |
| Total: | 100.00% |

Sample 6 contained 3% Tetranyl® L6/90 in place of the Tetranyl® AT7590 used in Sample 5 and 0.96% BKC and 2.4% DDAC, rather than the 2.550% BKC and 1.080%, DDAC used in Sample 5.

The results from the antimicrobial efficacy tests are given in the table below.

| | | | Log reduction | | | |
|---|---|---|---|---|---|---|
| | | Contact | | | | P. |
| Sample | Dilution | time | E. coli | S. aureus | E. hirae | aeruginosa |
| 5 | 1:159 | 22 min | >5.09 | >5.65 | >5.41 | >5.28 |
| 6 | 1:159 | 22 min | >5.07 | >5.09 | >5.10 | >5.03 |

### Antimicrobial Efficacy (China Technical Standard)

Sample 1 above was evaluated for its antimicrobial efficacy against Staphylococcus aureus Escherichia coli, and Candida albicans according to China Technical Standard TSD 2.1.1.9/2.1.1.7. The results from the antimicrobial efficacy tests are given in the table below.

Log reduction

| Dilution | Contact time | E. coli | S. aureus | C. albicans |
|---|---|---|---|---|
| 1:50 | 5 min | — | — | >5.45 |
| | | | | 5.04 |
| | | | | 5.11 |
| | 5 min | >6.66 | >6.62 | — |
| | | >6.68 | >6.57 | |
| | | >6.70 | >6.56 | |
| 1:125 | 5 min | >6.66 | >6.62 | — |
| | | >6.68 | >6.57 | |
| | | >6.70 | >6.56 | |
| 1:416 | 5 min | >6.66 | 6.62 | — |
| | | >6.68 | 6.57 | |
| | | >6.70 | 6.56 | |

### Fabric Softening

Two fabric softeners according to the invention were tested against existing laundry products, including two laundry softeners, a laundry detergent and a laundry sanitizer. The test was performed in accordance with ASTM D5237-14 “Standard Guide for Evaluating Fabric Softeners (modified)”.

### Method

A fabric bundle consisting of poly/cotton, cotton, and cotton terry looped towels, was washed with AATCC standard detergent and rinsed using the samples. After wash/rinse completion, towels were removed and conditioned overnight at 23° C., 50% Relative Humidity (RH). Substrates were then prepared for panel evaluation.

20 individual panellists evaluated the blinded samples based on a Ranking Comparison. Prior to evaluations, each panellist was instructed to wash and dry hands. If re-evaluations were needed, panellists were instructed to evaluate different sections of the towel. Panellists were presented with a group of six test fabrics on a table, with each fabric presented randomly and containing a different softener treatment and a blinded control. Each of the substrates were ranked from least to most soft, with no ties allowed, using a rating scale ranging from 1-6, with 1 being the least soft and 6 being the softest. The evaluations were all completed within the span of 2 hours. Fisher's LSD for ranked sums was performed to determine statistically significant differences, if any, between all products. Based on Fisher's LSD, any two samples can be described as significantly different if their ranked sums differ by more than the value calculated in LSDᵣₐₙₖ. All data and results can be found below.

### Samples:

| Sam- | |
|---|---|
| ple | Description |
| 7 | composition containing BKC, DDAC and Tetranyl ® AT7590 |
| 8 | composition containing: BKC, DDAC and Tetranyl ® L6/90 |
| E | commercially available fabric softener containing: 5-15% cationic |
| | surfactants; <5% perfume; DMDM hydantoin, and potassium |
| | sorbate |
| F | commercially available laundry detergent containing: alcohol |
| | ethoxylate 7EO; sodium laureth sulfate; ethanol; sodium citrate; |
| | sodium alkylbenzene sulfonate; protease; propylene glycol; sodium |
| | cocoate; sodium iminodisuccinate; triethanolamine; disodium |
| | distrylbiphenyl dissulfonate; sodium polyacrylate; calcium |
| | chloride; bronopol; sodium nitrate; 5-chloro-2-methyl-4- |
| | isothiazolin-3-one, and 2-methyl-4-isothiazolin-3-one |
| G | commercially available laundry sanitizer containing: BKC and |
| | DDAC |
| H | commercially available fabric softener containing: 5-15% cationic |
| | surfactants; <5% perfume; alpha-isomethylionone; citronellol; |
| | eugenol; hexyl cinnamal; limonene; DMDM hydantoin, and |
| | potassium sorbate |

### Results

| Subject | 7 | 8 | E | F | G | H |
|---|---|---|---|---|---|---|
| 1 | 5 | 4 | 3 | 2 | 1 | 6 |
| 2 | 5 | 2 | 4 | 3 | 6 | 1 |
| 3 | 2 | 5 | 3 | 1 | 6 | 4 |
| 4 | 5 | 2 | 6 | 1 | 3 | 4 |
| 5 | 3 | 2 | 5 | 1 | 1 | 6 |
| 6 | 6 | 2 | 1 | 3 | 5 | 4 |
| 7 | 2 | 5 | 3 | 1 | 4 | 6 |
| 8 | 1 | 3 | 4 | 5 | 2 | 6 |
| 9 | 6 | 4 | 3 | 1 | 2 | 5 |
| 10 | 6 | 4 | 5 | 1 | 2 | 3 |
| 11 | 4 | 5 | 6 | 1 | 2 | 3 |
| 12 | 3 | 4 | 6 | 1 | 5 | 2 |
| 13 | 2 | 3 | 4 | 6 | 5 | 1 |
| 14 | 5 | 1 | 6 | 2 | 4 | 3 |
| 15 | 5 | 6 | 4 | 2 | 3 | 1 |
| 16 | 3 | 5 | 2 | 1 | 4 | 6 |
| 17 | 6 | 4 | 1 | 2 | 3 | 5 |
| 18 | 6 | 2 | 4 | 1 | 3 | 5 |
| 19 | 5 | 1 | 6 | 2 | 3 | 4 |
| 20 | 6 | 5 | 3 | 2 | 1 | 4 |
| Average | 4.3 | 3.45 | 3.95 | 1.95 | 3.25 | 3.95 |
| Sum | 86 | 69 | 79 | 39 | 65 | 79 |

### Results

At a significance level of α=0.05, the LSDᵣₐₙₖ was determined to be 23.19. All five Samples performed significantly better in softness than Sample F (control). Samples 7, 8, E and H, the softener samples, performed better than the sanitizer Sample F. Sample 7, a softener according to the invention, outperformed the other samples. Samples 7, 8, E, G and H did not perform significantly better than each other.

### CONCLUSION

Thus, the laundry compositions comprising cationic biocidal actives, cationic fabric softeners, and an unsaturated fatty alcohol emulsifier were surprisingly found to be stable over prolonged periods of time and at all conditions even using a different method of manufacture. These compositions provided a 5-log reduction in the number of bacteria cells, i.e. killed 99.999% of bacteria, while also providing a fabric softening effect comparable to existing commercially available fabric softeners.

1. A laundry composition comprising:
a) about 1 to about 5 wt % of at least one cationic biocidal active;
b) about 1 to about 25 wt % of at least one cationic fabric softener, and
c) about 0.5 to about 4 wt % of at least one emulsifier,
wherein the at least one emulsifier is an unsaturated fatty alcohol; and
wherein the at least one cationic fabric softener is a cationic quaternary ammonium surfactant containing ester linkages (esterquat).

2. The laundry composition according to claim 1, wherein the at least one emulsifier is an unsaturated fatty alcohol containing at least one cis double bond or wherein the at least one emulsifier is a monounsaturated fatty alcohol.

3. The laundry composition according to claim 2, wherein the at least one emulsifier is a C₈₋₂₆ unsaturated fatty alcohol.

4. The laundry composition according to claim 1, wherein the at least one cationic biocidal active is selected from one or more quaternary ammonium compounds selected from:
one or more dialkyldimethyl ammonium chloride (DDAC), where each alkyl group is independently selected from straight chain C₈-C₁₀ alkyl;
one or more alkyl dimethyl benzyl ammonium chloride (ADBAC also known as BKC): 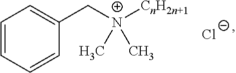
where n=8-18;
one or more alkyl dimethyl ethylbenzyl ammonium chloride (ADEBAC also known as EBC);
combinations of ADBAC, ADEBAC, and/or DDAC.

5. The laundry composition according to claim 1, wherein the at least one cationic biocidal active is BKC or DDAC or a combination of ADBAC and DDAC.

6. The laundry composition according to claim 1, wherein the at least one cationic fabric softener is a cationic quaternary ammonium surfactant containing ester linkages (esterquat) derivable from the reaction of triethanolamine with fatty alcohols.

7. The laundry composition according to claim 1, wherein the laundry composition comprises:
about 2 to about 4 wt % of the at least one cationic biocidal active;
about 1 to about 10 wt % of the at least one cationic fabric softeners, and
about 1 to about 3 wt % of the at least one emulsifier.

8. The laundry composition according to claim 1, wherein the laundry composition comprises:
about 2.4 wt % or about 3.36 wt % of the at least one cationic biocidal active;
about 2.7 wt % of the at least one cationic fabric softeners, and
about 2 wt % of the at least one emulsifier.

9. The laundry composition according to claim 1, wherein the weight ratio of the at least one cationic biocidal active:at least one cationic fabric softeners:at least one emulsifier is 1-40:1-40:1.

10. The laundry composition according to claim 1, wherein the weight ratio of the at least one cationic biocidal active:at least one cationic fabric softeners:at least one emulsifier is about 1.2:1.35:1.

11. The laundry composition according to claim 1, wherein the laundry composition comprises:
i. about 1.44 wt % or about 2.8 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzyl ammonium chloride: 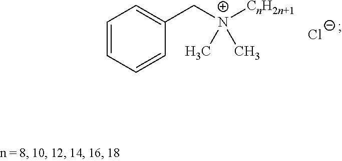
iii. about 2.70 wt % of cationic fabric softeners, and
iv. about 2.00 wt % oleyl alcohol.

12. The laundry composition according to claim 11, wherein the laundry composition further comprises:
v. about 1 wt % solvent, and
vi. about 1 wt % non-ionic surfactant.

13. A method of sanitizing and softening laundry during a laundry washing process comprising adding from about 30 to about 180 ml of the laundry composition according to claim 1 to the fabric softener compartment of an automatic washing machine and using the automatic washing machine to perform a laundry washing process.

14. (canceled)

15. A method of stabilising a cationic liquid dispersion containing at least one cationic surfactant, comprising adding an unsaturated fatty alcohol emulsifier to a liquid dispersion containing the at least one cationic surfactant, wherein the at least one cationic surfactant is a mixture of at least one cationic biocide and at least one cationic fabric softener.

16. The laundry composition of claim 3, wherein the at least one emulsifier is a C₁₂₋₂₆ unsaturated fatty alcohol.

17. The laundry composition of claim 16, wherein the at least one emulsifier is oleyl alcohol (cis-9-octadecen-1-ol), palmitoleyl alcohol (cis-9-hexadecen-1-ol), erucyl alcohol (cis-13-docosen-1-ol), or combinations thereof.

18. The laundry composition according to claim 4, wherein the at least one cationic biocidal active is selected from ADBAC and DDAC; ADBAC and ADEBAC; or ADBAC, ADEBAC, and DDAC.

19. The laundry composition according to claim 6, wherein the at least one cationic fabric softener is a partially hydrogenated palm esterquat or a partially hydrogenated tallow esterquat.

20. The laundry composition of claim 12, wherein the solvent is propylene glycol.

21. The laundry composition of claim 12, wherein the non-ionic surfactant is an alcohol ethoxylate.
